(19) United States
(12) Patent Application Publication
(10) Pub. No.: US 2019/0141125 A1
(43) Pub. Date: May 9, 2019

(54) CROSS APPLICATION ACCESS PROVISIONING SYSTEM

(71) Applicant: Bank of America Corporation, Charlotte, NC (US)

(72) Inventors: Michael Emil Ogrinz, Easton, CT (US); Graham M. Wyllie, Charlotte, NC (US); Shivanshu Govind Murarka, Mumbai (IN)

(21) Appl. No.: 15/802,613

(22) Filed: Nov. 3, 2017

(51) Int. Cl. H04L 29/08; H04L 29/06

(52) U.S. Cl. CPC H04L 67/1091; H04L 69/14; H04L 67/1093

(57) ABSTRACT

The invention utilizes a plurality of robotic process automation (RPA) bots to provide cross-technology user access provisioning across multiple applications. Typically, an entity system comprises a plurality of different systems, such as mainframe systems, client applications, web applications, and the like. As such, a user typically must input an access request into several different systems or applications in order to complete a task. By utilizing RPA, the invention is able to provision user access through a single request across all of the systems to which the user must be given access to complete the task.

### FIELD OF THE INVENTION

The present invention embraces a system, computer program product, and computer-implemented method for utilizing robotic process automation to provide real-time provisioning of user access across multiple applications.

### BACKGROUND

In the computing context, it is often desirable to provision user access to applications within an entity's network. Traditional methods of user access provisioning presents a number of technical challenges. First, user access is typically provided manually on a per-application basis, thereby creating inefficiencies. Second, allowing provisioned user access to remain beyond the length of time needed by the user has been completed reduces the overall security of the system. Accordingly, there is a need for a way to provision user access efficiently and securely across multiple applications within the entity's system on a real-time and as-needed basis.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention utilizes a plurality of robotic process automation (RPA) bots to provide cross-technology user access provisioning across multiple applications. Typically, an entity system comprises a plurality of different systems, such as mainframe systems, client applications, web applications, and the like. As such, a user typically must input an access request into several different systems or applications in order to complete a task. By utilizing RPA, the invention is able to provision user access through a single request across all of the systems to which the user must be given access to complete the task.

Furthermore, the system may use RPA to identify user patterns in inputs or behavior and index the patterns. The system may use the collected data to create a profile of the user, then subsequently use a predictive analytics module to predict the needs of the user as the user completes tasks within the entity's systems.

The system may further comprise a plurality of RPA chat bots to identify standard user patterns in errors or issues with applications. The RPA chat bots may be configured to provide users with executable code to automatically resolve the user's issues within an application.

Accordingly, embodiments of the present invention provide a system, computer program product, and computer-implemented method for utilizing robotic process automation to provide real-time provisioning of user access across multiple applications. The invention comprises detecting that a user requires access to a first entity application and a second entity application; receiving, via a provisioning RPA bot, user data from the user; based on the user data, generating authentication credentials for the first entity application and the second entity application; providing the authentication credentials for the first entity application and the second entity application to the user; detecting that the user no longer requires access to the first entity application; and automatically invalidating the authentication credentials for the first entity application.

In some embodiments, the invention further comprises detecting that the user no longer requires access to the second entity application; and automatically invalidating the authentication credentials for the second entity application.

In some embodiments, the invention further comprises detecting that the user once again requires access to the first entity application; and automatically restoring the authentication credentials for the first entity application.

In some embodiments, the invention further comprises detecting that the user once again requires access to the second entity application; and automatically restoring the authentication credentials for the second entity application.

In some embodiments, the invention further comprises generating a user profile associated with the user; associating the user data with the user profile; detecting, via a chat RPA bot, a user issue within the second entity application; searching, via the chat RPA bot, a help database, the help database comprising a plurality of support files; identifying, based on the user data, a proposed solution to the user issue within the second entity application, wherein the proposed solution comprises a support file; and deploying the proposed solution to a user computing system.

In some embodiments, detecting the user issue within the second entity application comprises detecting an error message within a user interface using OCR.

In some embodiments, deploying the proposed solution to the user computing system comprises executing a script within the support file of the proposed solution on the user computing system.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts a block diagram illustrating an operating environment for the RPA bot system, in accordance with one embodiment of the present invention;

FIG. 2 depicts a block diagram illustrating the user computing system, the entity computing system, the bot computing system, and the database server in more detail, in accordance with one embodiment of the present invention;

FIG. 3 depicts a process flow illustrating the use of RPA bots for providing real-time provisioning of user access across multiple applications, in accordance with one embodiment of the present invention; and

FIG. 4 depicts a process flow for using robotic process automation to automatically deploy technical support files, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Robotic process automation” or “RPA” as used herein may refer to the automation of high-volume processes using bots.

“Bot” as used herein may refer to a software application that performs automated tasks. In particular, a plurality of bots may be used by an entity to perform various functions for high-volume applications that relate to the entity's objectives. Typically, a bot will be configured to repeatedly perform a specific task. Each bot may be configured to utilize particular protocols and be compatible with particular platforms and applications. In some embodiments, a bot may be configured to execute its tasks by interacting with other applications within the entity's systems at the interface level (i.e. by providing inputs to the interfaces of the other applications).

“Entity” as used herein may refer to an individual or an organization that owns and/or operates a system of networked computing devices and/or systems on which a plurality of bots are implemented. The entity may be a business organization, a non-profit organization, a government organization, and the like.

“User” as used herein may refer to an individual who may log onto the system to view and/or manage the functioning of the RPA bots. Typically, the user is authorized by the entity to access the system. Accordingly, in some embodiments, the user may be an employee of the entity such as an administrator.

“Computing system” as used herein may refer to a networked computing device within the entity system. The computing system may include a processor, a non-transitory storage medium, a communications device, and a display. The computing system may support user logins and inputs from any combination of similar or disparate devices. Accordingly, the computing system may be a portable electronic device such as a smartphone, tablet, or laptop, or the computing may be a stationary unit such as a personal desktop computer or networked terminal within an entity's premises. In some embodiments, the computing system may be a local or remote server which is configured to send and/or receive inputs from other computing systems on the network.

Embodiments of the present invention provide a system, computer program product, and method for utilizing robotic process automation to provide real-time provisioning of user access across multiple applications. In a typical scenario, an entity may wish to authorize a user, such as an employee or administrator of the entity, to access multiple applications within the entity's systems in order to complete a particular task. In such scenarios, the entity's systems may utilize a provisioning RPA bot to provision access on a limited, real-time basis for the specific purpose of accomplishing the particular task. The provisioning RPA bot may receive the various input data necessary to provision application access, such as the user's identity, the nature of the task, the applications required to accomplish the task, the authorizing entity, and the like. The provisioning RPA bot may then automatically generate authentication credentials for the user to access all of the disparate applications to which the user must be granted access. Once the user has completed the task, the provisioning RPA bot may automatically detect the completion of the task and revoke access to the applications until the user requires them once again. By using the provisioning RPA bot in this manner, the system is able to efficiently provision access to multiple applications while simultaneously increasing the security of the entity's systems by closing access to applications when not expressly necessary to accomplish a certain task.

In some embodiments, the system may further comprise a predictive analytics module which actively gathers data regarding the user, such as user patterns, inputs, behaviors, status, identity, and the like. In an exemplary embodiment, the user may be an employee of the administrator of the entity. In such a case, the predictive analytics module may gather data on the user's role, tasks, and behaviors to determine the types of applications that the user is likely to require or utilize. In some embodiments, the predictive analytics module may detect that the user has gained expertise in a particular subject matter (e.g. programming in JAVA), and utilize a profile RPA bot to recommend that the user complete a training module in the particular subject matter.

In some embodiments, the system may further comprise a tech support chat RPA bot which is configured to interact with the user to identify errors or issues within applications. In some embodiments, the chat RPA bot may be configured to search an internal database and provide a script or macro to resolve the user's issue automatically. In some embodiments, the chat bot may be configured to utilize the data collected by the predictive analytics module to track which applications the user may be currently using or may use in the near future. By tracking the profile of the user, the system may be able to proactively provide solutions to commonly encountered errors or issues within the applications that the user may be using to accomplish a particular task. Furthermore, the chat RPA bot may use the user's profile data to determine how to efficiently direct the search for a solution. For instance, if the chat RPA bot reads from the profile data that the user commonly programs using JAVA, the chat RPA bot may begin the search for a solution within the section of the help database corresponding to JAVA applications or development kits. In this way, the system may typically be able to produce a solution in an expedient and resource-efficient manner by increasing the likelihood of finding a solution earlier in the search.

Utilizing RPA bots in this way to provision application access and provide technical support addresses a number of computer technology-centric challenges. By utilizing real-time provisioning RPA bots to provision and remove application access based on user profile data, the system is able to both increase the computing efficiency and the security of the provisioning process. Furthermore, utilizing the predictive analytics module in conjunction with the chat RPA bots allows the system to prevent the waste of computing resources involved in providing solutions to application errors or issues, which in turn increasing the computing efficiency of the entity system. Such computing resources may include processing power, memory space, storage space, cache space, electric power, networking bandwidth, and the like.

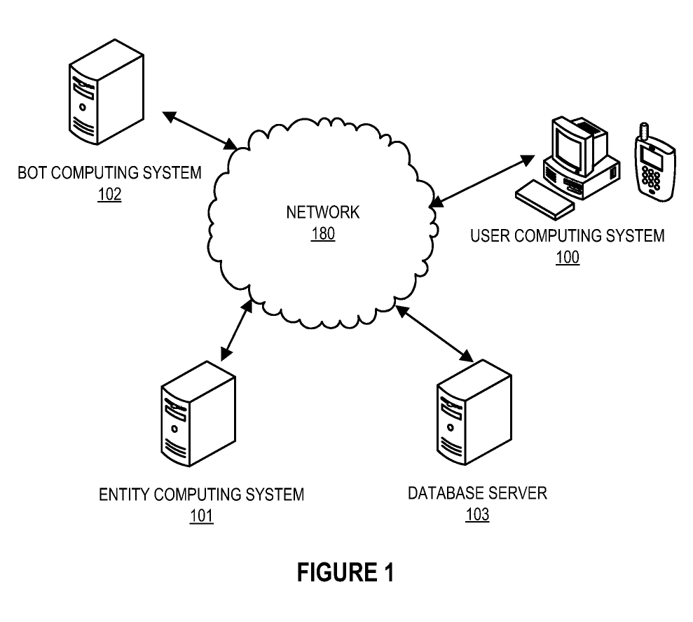

FIG. 1 is a block diagram illustrating an operating environment for the RPA bot system, in accordance with one embodiment of the present invention. The operating environment may include a user computing system 100 in operative communication with an entity computing system 101, a bot computing system 102, and a database server 103 over a network 180. The network 180 may also be a global area network (GAN), such as the Internet, a wide area network (WAN), a local area network (LAN), or any other type of network or combination of networks. The network 180 may provide for wireline, wireless, or a combination wireline and wireless communication between devices on the network 180. The user computing system 100 is typically a device that may be operated by a user, where the device may be a mobile device such as a smartphone, tablet, or laptop, a personal computing device such as a desktop computer, smart device, single board computer, or a device owned and operated by an entity, such as a computer system terminal located on the entity's premises. In some embodiments, the user is an employee of the entity such as an administrator of the RPA bot system who is authorized to access the entity computing system 101, the bot computing system 102, and/or the database server 103.

Typically, the entity computing system 101 stores and runs the server-side applications to which the user is provisioned access. In particular, the entity computing system 101 may contain the various applications and data stores required for the user to accomplish a particular task. Each application within the entity computing system 101 may require user data to be inputted into the various applications in order to authorize the user to access the applications. Accordingly, a provisioning RPA bot may collect user-inputted data, such as user identity, user status, the nature of the task, the duration of the task, etc., and automatically input the appropriate user data into the various applications to provision access to the user. In some embodiments, the entity computing system 101 may further comprise a predictive analytics module, which gathers and analyzes data of each user within the entity's system. Such user data may be stored, for instance, in the database server 103. By gathering various user metrics, such as the status of the user, tasks assigned to the user, subject matter expertise of the user, and the like, the system is able to predict the access, training, and support needs of the user, which in turn leads to increases in efficiency within the system.

The bot computing system 102 typically stores the various RPA bots used by the system. In some embodiments, the bot computing system 102 may store the provisioning RPA bot, which gathers the user data needed to provision application access. In some embodiments, the provisioning RPA bot may be configured to selectively and automatically provide and revoke access to one or more applications on the entity computing system 101 based on the user's participation in a work flow. For example, a new user may be tasked with a new coding project. In such a scenario, the provisioning RPA bot may gather the new user's data and selectively provision access to the applications needed for the new user to participate in the coding project by generating authentication credentials that the user may use to access the applications. Authorization data may then be generated based on the authentication credentials, which may include a username and password, a PIN, biometric data, a secure token, and the like, and may be stored within the database server 103. The provisioning RPA bot may be configured to automatically send the authentication credentials to the user (e.g. send a username and password to the user through electronic mail, SMS, or other communications program), or automatically install the components necessary for the user computing system 100 to authenticate the user (e.g. install the secured token on the user computing system 100). When the provisioning RPA bot detects that the coding project has been completed or canceled, or the new user is no longer involved in the coding project, the provisioning RPA bot may automatically revoke the user's authentication credentials (e.g. by deleting the authentication credentials from the database server 103).

The bot computing system 102 may further comprise a profile RPA bot which continuously monitors the user data and reports the data to the predictive analytics module. In an exemplary embodiment, the profile RPA bot may track the user's behaviors and/or subject matter expertise, such as whether the user tends to prefer a particular editor or compiler, or whether the user is skilled in a particular programming language. The profile RPA bot may report this data back to the predictive analytics module, which may then be used to generate a recommendation to the user. For example, the predictive analytics module may be configured to recommend to the user that the user enrolls in a particular training module based on the user's preferences or expertise. The predictive analytics module may send an alert to the user computing system 100, where the alert may activate an output device located on the user computing system 100 to, for example, display a notification to the user or sound an audible notification.

The bot computing system 102 may further comprise a chat RPA bot which serves to provide technical support for the user with respect to the applications on the entity computing system 101. In an exemplary embodiment, the user may use a natural language to input a query to the chat RPA bot regarding a technical issue that the user is currently experiencing with a particular application. The chat RPA bot may receive the query, translate the query, and search an existing help database within the database server 103. In other embodiments, the chat RPA bot may search external sources for a solution to the user's issue. Once a potential solution has been found, the chat RPA bot may be configured to provide the solution to the user. The solution may be provided, for instance, in a chat window, a pop-up notification, an e-mail, a hyperlink to a web page, and the like. In some embodiments, the chat RPA bot may be configured to provide a script or macro that, when executed by the user computing system 100, automatically resolves the issue that the user is experiencing within the application. In some embodiments, the system may, by analyzing the user data, narrow the initial database search based on the user's status. For example, if the user is currently authorize to use certain applications, the chat RPA bot may be configured to first search the areas of the database server 103 which correspond to the applications being used by the user. In this way, the chat RPA bot is more likely to find a solution more efficiently and expediently.

The user computing system 100 may be used by a user to accomplish a certain task on behalf of the entity. In such embodiments, the user computing system 100 may be configured to authenticate the user and thereafter access the various applications on the entity computing system 101 in order to accomplish the task. The user computing system 100 may further track user inputs and behavior and provide the user data to the predictive analytics module stored within the entity computing system 101. In other embodiments, the user computing system 100 may be used by an administrator of the entity to access the bot computing system 102 and/or the database server 103 to manage and configure the various RPA bots on the bot computing system 102 and/or the user profile data or help database stored on the database server 103.

It should be understood by those having ordinary skill in the art that although the entity computing system 101 and the bot computing system 102 as depicted are depicted as single computing systems, both the entity computing system 101 and the bot computing system 102 may represent multiple computing systems which, in some embodiments, may be operating in a distributed fashion. Accordingly, it should be further understood that the database server 103 may exist on a single server or on multiple servers in a distributed configuration. It should also be understood that the user computing system 100 may represent a plurality of different computing systems within the entity system.

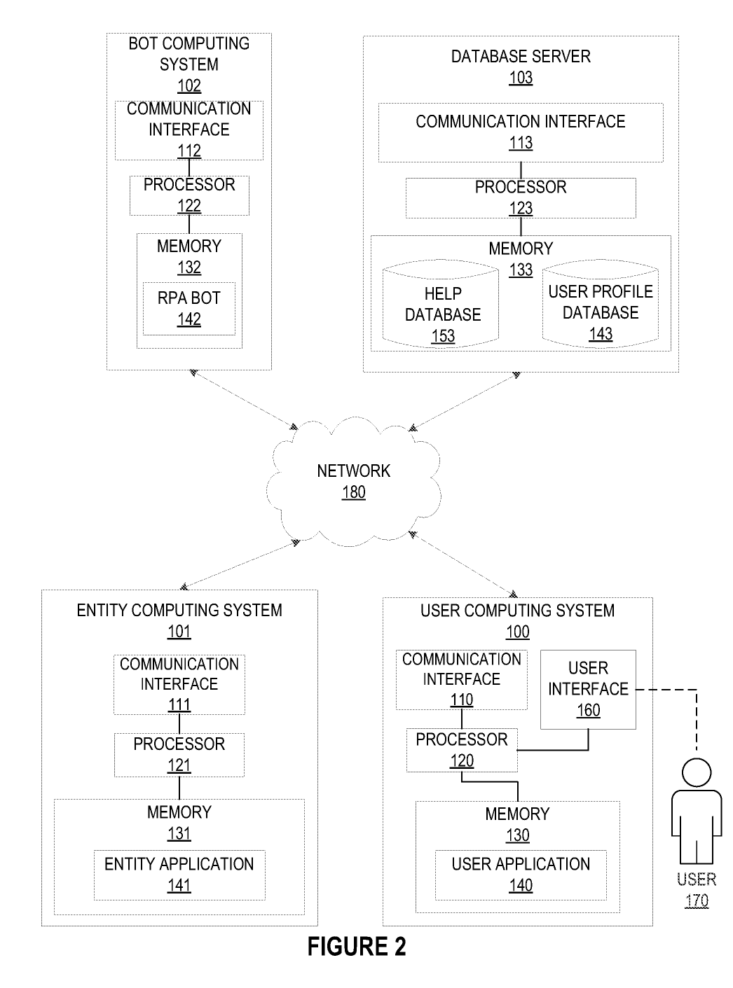

FIG. 2 is a block diagram illustrating the user computing system 100, the entity computing system 101, the bot computing system 102, and the database server 103 in more detail, in accordance with one embodiment of the present invention. The entity computing system 101 typically contains a processor 121 communicably coupled to such devices as a communication interface 111 and a memory 131. The processor 120, and other processors described herein, typically includes circuitry for implementing communication and/or logic functions of the entity computing system 101. For example, the processor 121 may include a digital signal processor device, a microprocessor device, and various analog to digital converters, digital to analog converters, and/or other support circuits.

The entity computing system 101 may use the communication interface 111 to communicate with other devices over the network 180. The communication interface 111 as used herein may include an Ethernet interface, an antenna coupled to a transceiver configured to operate on a cellular data or WiFi signal, and/or a near field communication (“NFC”) interface.

The entity computing system 101 may include a memory 131 operatively coupled to the processor 121. As used herein, memory includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like. The memory 131 within the entity computing system 101 may comprise an entity application 141, which is the application to be accessed by the user to accomplish a particular task. The entity application 141 may comprise a plurality of disparate applications for which the user must be provisioned access. In some embodiments, the entity application 141 may further comprise the predictive analytics module which gathers and analyzes user data to provide recommendations or make efficiency adjustments to the entity system.

The bot computing system 102 may comprise a communication interface 112, a processor 122, and a memory 132 having one or more RPA bots 142 stored thereon. Typically, the RPA bots 142 are be configured to repeatedly execute a specific task in high volume applications. In particular, the RPA bots 142 may comprise the provisioning RPA bots which gather the user inputted data required to provision user access to the entity application 141. The RPA bots 142 may further comprise a profile RPA bot which collects the user inputted data to determine patterns in behavior and/or suggest future steps or actions to the user. The RPA bots 142 may further comprise a chat RPA bot which is configured to receive queries from the user regarding an issue that the user is experiencing within the entity application 141, query the database computing system 103 and/or external sources for a solution, and present the solution to the user.

The database server 103 may also comprise a communication interface 113, a processor 123, and a memory 133 having a user profile database 143 and a help database 153 stored thereon. It should be appreciated that the databases within the database server 103 may also exist in a distributed manner amongst a plurality of computing systems. The user profile database 143 may contain the various types of user data collected by the predictive analytics engine about each user within the entity system. The various types of user data may include user status (name, title, role), projects with which the user is involved, actions that the user takes within the entity system, behavior of the user (e.g. duration of logged in session, time of log in, applications opened, etc.), subject matter expertise of the user (e.g. specialization in a particular area of programming), and the like. The predictive analytics engine may utilize the user data to execute the various functions of the RPA bots. For instance, the user data may be used to determine which applications to which the user requires access or may require in the near future. Upon making this determination, the system may use the provisioning RPA bot to grant access to the entity application 141 on an as-needed basis.

The help database 153 may comprise technical support data regarding the various applications typically used by the entity, such as the entity application 141. The help database 153 may comprise a plurality of support files, which may include scripts, macros, executables, articles, discussions, correspondences, and the like, which are directed to the problems that may be encountered when using the entity application 141. In some embodiments, the help database 153 is divided according to the application to which the support files relate. Accordingly, the chat RPA bot may begin the search at the sections of the help database 153 which correspond to the applications that the user is currently authorized to use. In some embodiments, the chat RPA bot may further narrow the search of the help database 153 based on the user profile data. For instance, the user profile data may reveal all of the applications which the user is authorized to access. Based on this, the chat RPA bot may more easily detect issues arising out of an incompatibility between or among the various applications that the user may be running on the user computing system 100. Accordingly, the chat RPA bot may determine that the issue is likely the result of an incompatibility and begin the search with the support files that deal with incompatibility, thereby further increasing the chance that a solution will be issued efficiently and expediently.

The user computing system 100 typically also includes a processor 120 operatively coupled to a communication interface 110 and a memory 130. The memory 130 may contain a user application 140 which causes the processor 120 to display a user interface 160 to a user 170. The user interface 160 may comprise the hardware and software implements necessary to accept input from and provide output to the user. Accordingly, the user interface 160 may comprise hardware such as a display, audio output devices, projectors, and the like, or input devices such as keyboards, mice, motion sensors, cameras, biometric sensors, and the like. The user interface 160 may further comprise software such as a graphical or command-line interface through which the user may provide inputs and/or receive outputs from the user computing system 100. It should be understood that the display on which the user interface 160 is presented may include an integrated display (e.g. a tablet or smartphone screen) within the user computing system 100, or an external display device (e.g. a computer monitor or television). In some embodiments, the user 170 may be an employee of the entity who has been assigned a particular task or role within a project. In such embodiments, the user application 140 within the memory 130 may be a client application to allow the user 170 to access the entity application 141. In other embodiments, the application within the memory 130 may be a general purpose application such as an operating system. The application, upon receiving input from the user 170, may cause the processor 120 to, through the communication interface 110, establish a communication link to the communication interface 111 of the entity computing system 101 to allow the user 170 to access the entity application 141 to accomplish the user's tasks. In other embodiments, the user 170 may be an administrator of the entity system. In such embodiments, the user application 140 may be an administrator application which allows the user 170 to access and configure the RPA bot 142, the entity application 141, the predictive analytics module, and/or the help database 153 and the user profile database 143.

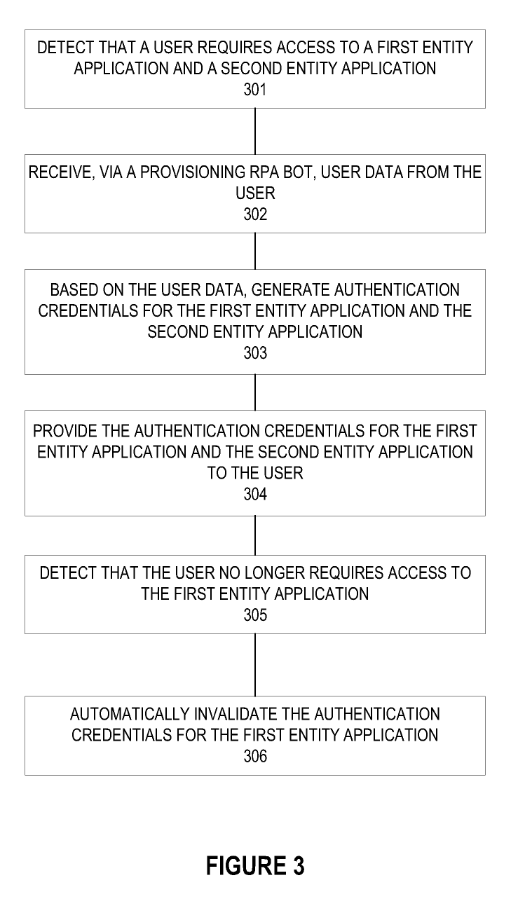

FIG. 3 is a process flow illustrating the use of RPA bots for providing real-time provisioning of user access across multiple applications, in accordance with one embodiment of the present invention. The process begins at block 301, where the system detects that a user requires access to a first entity application and a second entity application. In a typical embodiment, a user may be a new employee of the entity or an employee who is joining a particular work project of the entity. In such embodiments, the first entity application and the second entity application may represent applications to which the user requires access in order to accomplish the tasks assigned to the user. For instance, the first entity application may be a source code editor and the second entity application may be an asset viewer.

The process continues to block 302, where the system receives, via a provisioning RPA bot, user data from the user. Typically, the user data comprises the information necessary to authorize the user to access the entity applications. The user data may include the user's biographical information, the user's status within the entity, the projects with which the user is involved, the tasks that have been assigned to the user, and the like. The user data may further comprise information related to authentication credentials, such as a desired username and password.

The process continues to block 303, where the system, based, on the user data, generates authentication credentials for the first entity application and the second entity application. In some embodiments, the required user data for the first entity application may differ from the required user data for the second entity application. For instance, the first entity application may require that the user have a particular title within the entity, while the second entity application may require only that the user creates a username and password to access the application. The user data required by the various entity applications may be determined in part by the sensitive nature of the data accessible within the particular entity application, i.e. applications giving access to more sensitive data may impose stricter user data requirements in order to generate the authentication credentials.

The system continues to block 304, where the system provides the authentication credentials for the first entity application and the second entity application to the user. Upon generating authentication credentials configured to authorize the user for the first entity application and the second entity application, the system may provide the authentication credentials through various methods. In some embodiments, the system may communicate the authentication credentials to the user via e-mail, SMS, instant message, voicemail, and the like. Such methods may be used, for instance, if the authentication credentials are a username and password, a PIN, a unique key, and the like. In other embodiments, the system may be configured to automatically install the authentication credentials on the user computing system. For instance, such a method may be used if the authentication credential is a temporary secure token, a cryptographic key, and the like.

The system continues to block 305, where the system detects that the user no longer requires access to the first entity application. This may occur, for example, if the user completes the tasks for which access to the first entity application is necessary, if the user experiences a change in status, the user goes on a hiatus or vacation, or if the user stops working on a particular project. In some embodiments, the user may indicate to the system through the user application that the user no longer requires access to the first entity application. In other embodiments, the system may automatically detect that the user no longer requires access to the first entity application, such as by determining that the duration of the authorized access has expired, or that the user data mined by the predictive analytics module has indicated a change in the user's requirements.

The process concludes at block 306, where the system automatically invalidates the authentication credentials for the first entity application. In some embodiments, this step may involve the system changing the authorization data of the first entity application, where the authorization data may be an approved list of users, such as a whitelist. In other embodiments, the step may comprise automatically deleting the authentication credentials from the user computing system, such as deleting the secure authentication token on the user's device. In some embodiments, the user may once again require access to the first entity application. In such embodiments, the system may be configured to automatically restore the authentication credentials for the first entity application. In this way, the system is able to provision and restrict access to the various applications within the entity's systems on a real-time, as-needed basis in order to minimize the security risk of application access during inactive periods.

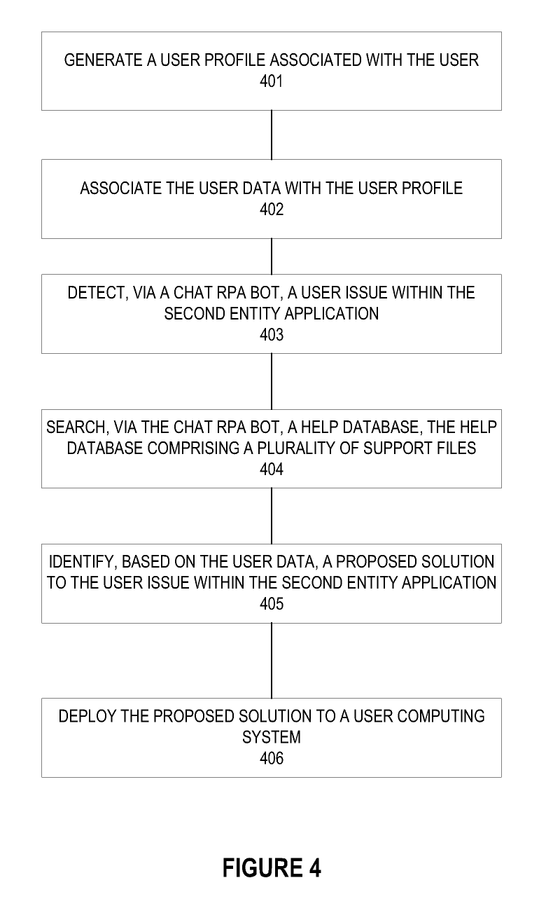

FIG. 4 illustrates a process flow for using robotic process automation to automatically deploy technical support files, in accordance with one embodiment of the present invention. The process begins at block 401, where the system generates a user profile associated with the user. Typically, each user will be associated with a specific user profile.

The process continues to block 402, where the system associates the user data with the user profile. Typically, the predictive analytics engine utilizes a profile RPA bot to constantly monitor the user computing system to extract user data, such as the types of applications being used, user actions or behaviors, and the like. The system may further add to the user profile the user data received from the user for the purposes of provisioning application access, such as the tasks that the user has been assigned or the projects on which the user is currently working.

The process continues to block 403, where the system detects, via a chat RPA bot, a user issue within the second entity application. In some embodiments, the user may provide an input to the chat RPA bot using natural language. For instance, the user may type “my compiler is crashing unexpectedly” into a text entry field provided on the user interface by the chat RPA bot. In other embodiments, the chat RPA bot may capture error messages on the user's display by methods such as OCR. The chat RPA bot may subsequently use the captured error message as the input needed to provide technical support.

The process continues to block 404, where the system searches, via the chat RPA bot, a help database, the help database comprising a plurality of support files. Using the input provided by the user (e.g. the natural language query or the captured error message data), the chat RPA bot may search the support files for a solution. The support files may include a number of items which may contain solutions to issues encountered within particular entity applications, such as executable files, scripts, macros, articles, discussion posts, tutorials, and the like. Typically, the support files within the help database is structured and organized according to the entity applications to which they relate. Accordingly, the chat RPA bot may, based on the user data, begin the search with the support files pertaining to the application at issue and/or the applications which the user is authorized to access. In this way, the system will typically be able to find a solution sooner than if the chat RPA bot simply began the search at a default starting location within the help database.

The process continues to block 405, where the system identifies, based on the user data, a proposed solution to the user issue within the second entity application. The chat RPA bot may, for instance, determine that a support file has a high correlation to the issue described in the natural language search based on the data within the support file. For instance, if the support file contains text data that describes in detail the type of symptoms expressed in the natural language query, the chat RPA bot may mark the support file as being highly relevant to the user's issue. In other embodiments, in cases in which the chat RPA bot has scraped error data from the user's display, the chat RPA bot may determine that a particular support file is associated with a particular error in the second entity application.

The process concludes at block 406, where the system deploys the proposed solution to a user computing system. In some embodiments, the deployment may involve sending the support file to the user, which may include displaying the text of the support file within a chat window in the user interface, sending the support file via e-mail, SMS, instant message, direct file transfer, FTP transfer, HTTP transfer, and the like. In some embodiments, deploying the proposed solution may include automatically executing the script or executable portion of the support file on the user computing system to resolve the issue within the second entity application. In some embodiments, the user may provide multiple support files at one time. In some embodiments, the chat RPA bot may be configured to query the user to determine whether the issue has been resolved after deploying the support file with the highest correlation rating. If the user confirms that the issue has been resolved, the chat RPA bot may mark the issue as resolved within the help database. If the user selects that the issue has not yet been resolved, the chat RPA bot may deploy the support file with the next highest correlation rating, and so on until all of the proposed solutions have been exhausted.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for utilizing robotic process automation to provide real-time provisioning of user access across multiple applications, comprising:
a bot computing system comprising:
a processor;
a communication interface; and
a memory having an RPA bot application stored therein, wherein the RPA bot application, when executed by the processor, causes the processor to:
detect that a user requires access to a first entity application and a second entity application;
receive, via a provisioning RPA bot, user data from the user;
based on the user data, generate authentication credentials for the first entity application and the second entity application;
provide the authentication credentials for the first entity application and the second entity application to the user;
detect that the user no longer requires access to the first entity application; and
automatically invalidate the authentication credentials for the first entity application.

2. The system according to claim 1, wherein the RPA bot application further causes the processor to:
detect that the user no longer requires access to the second entity application; and
automatically invalidate the authentication credentials for the second entity application.

3. The system according to claim 1, wherein the RPA bot application further causes the processor to:
detect that the user once again requires access to the first entity application; and
automatically restore the authentication credentials for the first entity application.

4. The system according to claim 2, wherein the RPA bot application further causes the processor to:
detect that the user once again requires access to the second entity application; and
automatically restore the authentication credentials for the second entity application.

5. The system according to claim 1, wherein the RPA bot application further causes the processor to:
generate a user profile associated with the user;
associate the user data with the user profile;
detect, via a chat RPA bot, a user issue within the second entity application;
search, via the chat RPA bot, a help database, the help database comprising a plurality of support files;
identify, based on the user data, a proposed solution to the user issue within the second entity application, wherein the proposed solution comprises a support file; and
deploy the proposed solution to a user computing system.

6. The system according to claim 5, wherein detecting the user issue within the second entity application comprises detecting an error message within a user interface using OCR.

7. The system according to claim 5, wherein deploying the proposed solution to the user computing system comprises executing a script within the support file of the proposed solution on the user computing system.

8. A computer program product for utilizing robotic process automation to provide real-time provisioning of user access across multiple applications, the computer program product comprising at least one non-transitory computer readable medium having computer-readable program code portions embodied therein, the computer-readable program code portions comprising:
an executable portion for detecting that a user requires access to a first entity application and a second entity application;
an executable portion for receiving, via a provisioning RPA bot, user data from the user;
an executable portion for, based on the user data, generating authentication credentials for the first entity application and the second entity application;
an executable portion for providing the authentication credentials for the first entity application and the second entity application to the user;
an executable portion for detecting that the user no longer requires access to the first entity application; and
an executable portion for automatically invalidating the authentication credentials for the first entity application.

9. The computer program product according to claim 8, the computer-readable program code portions further comprising:
an executable portion for detecting that the user no longer requires access to the second entity application; and
an executable portion for automatically invalidating the authentication credentials for the second entity application.

10. The computer program product according to claim 8, the computer-readable program code portions further comprising:
an executable portion for detecting that the user once again requires access to the first entity application; and
an executable portion for automatically restoring the authentication credentials for the first entity application.

11. The computer program product according to claim 9, the computer-readable program code portions further comprising:
an executable portion for detecting that the user once again requires access to the second entity application; and
an executable portion for automatically restoring the authentication credentials for the second entity application.

12. The computer program product according to claim 8, the computer-readable program code portions further comprising:
an executable portion for generating a user profile associated with the user;
an executable portion for associating the user data with the user profile;
an executable portion for detecting, via a chat RPA bot, a user issue within the second entity application;
an executable portion for searching, via the chat RPA bot, a help database, the help database comprising a plurality of support files;
an executable portion for identifying, based on the user data, a proposed solution to the user issue within the second entity application, wherein the proposed solution comprises a support file; and
an executable portion for deploying the proposed solution to a user computing system.

13. The computer program product according to claim 12, wherein detecting the user issue within the second entity application comprises detecting an error message within a user interface using OCR.

14. The computer program product according to claim 12, wherein deploying the proposed solution to the user computing system comprises executing a script within the support file of the proposed solution on the user computing system.

15. A computer-implemented method to provide real-time provisioning of user access across multiple applications, said method comprising:
detecting that a user requires access to a first entity application and a second entity application;
receiving, via a provisioning RPA bot, user data from the user;
based on the user data, generating authentication credentials for the first entity application and the second entity application;
providing the authentication credentials for the first entity application and the second entity application to the user;
detecting that the user no longer requires access to the first entity application; and
automatically invalidating the authentication credentials for the first entity application.

16. The computer-implemented method according to claim 15, the method further comprising:
detecting that the user no longer requires access to the second entity application; and
automatically invalidating the authentication credentials for the second entity application.

17. The computer-implemented method according to claim 15, the method further comprising:
detecting that the user once again requires access to the first entity application; and
automatically restoring the authentication credentials for the first entity application.

18. The computer-implemented method according to claim 16, the method further comprising configuring:
detecting that the user once again requires access to the second entity application; and
automatically restoring the authentication credentials for the second entity application.

19. The computer-implemented method according to claim 15, the method further comprising:
generating a user profile associated with the user;
associating the user data with the user profile;
detecting, via a chat RPA bot, a user issue within the second entity application;
searching, via the chat RPA bot, a help database, the help database comprising a plurality of support files;
identifying, based on the user data, a proposed solution to the user issue within the second entity application, wherein the proposed solution comprises a support file; and
deploying the proposed solution to a user computing system.

20. The computer-implemented method according to claim 19, wherein deploying the proposed solution to the user computing system comprises executing a script within the support file of the proposed solution on the user computing system.
